(19) United States
(12) Patent Application Publication
(10) Pub. No.: US 2012/0247872 A1
(43) Pub. Date: Oct. 4, 2012

(54) SAFETY SCAFFOLD

(76) Inventor: Delbert G. Liu, Dickerson, MD (US)

(21) Appl. No.: 13/427,531

(22) Filed: Mar. 22, 2012

Related U.S. Application Data
(60) Provisional application No. 61/468,963, filed on Mar. 29, 2011.

(51) Int. Cl. E04G 3/20; F16M 13/02

(52) U.S. Cl. 182/112; 248/201

(57) ABSTRACT

A construction safety device includes a wall bracket and a platform bracket. The wall bracket includes an interior member, a wall top member and an exterior member which are integrally formed. The wall bracket is placed over the wall. The platform support bracket is removably fixed to the wall bracket. A plurality of the construction safety devices is attached to the wall of a structure to form a construction safety system. A barrier and a platform are positioned over the construction safety devices.

### FIELD OF THE INVENTION

The present inventions relate to building equipment or construction equipment, for example, safety equipment for roofing and building scaffolding

### BACKGROUND

U.S. Pat. No. 4,852,692, titled ROOFING SAFETY DEVICE, describes a roofing safety device, adapted to be used in connection with substantially all roof configurations comprising an upright support, adapted to be secured to the roof of a building, having at least one self-braking mechanism and cable assembly attached thereto. Disposed at the free end of the cable is a fastening device which may be secured to one of a plurality of heavy rings secured to a belt. The plurality of rings provided on the belt enables the worker to attach the cable of the self-braking mechanism to either side of his body, thereby allowing the worker to perform his task on the roof without being chafed by the cable. A pair of stabilizing struts, each having a rectangular foot at the distal ends thereof which are rotatable about a pair of orthogonal axes enables the device to conform to substantially any rooftop configuration. The ability of the safety device to be used in connection with virtually all rooftops, combined with the non-irritating manner in which the device may be secured to the worker increases the likelihood that the device will be used habitually, so as to reduce the number of roofing injuries and deaths.

U.S. Pat. No. 5,503,358, titled SUSPENDED WALL SCAFFOLD STRUCTURE, describes a scaffold structure which may be suspended from the top of a wall to support wooden planks or the like in an elevated, horizontal position. The structure includes a main support member having a hanging bracket for engaging the top of the wall to support the main support member vertically along the wall. A platform member orthogonally projects from the main support member and receives the planks thereon. A brace member is connected to and extends between the main support member and the platform member to rigidify the structure of the invention. The structure may be compactly folded for transportation and storage, and an extension member is provided to facilitate positioning of the scaffolding atop second story or higher walls.

U.S. Pat. No. 5,829,549, titled WALKWAY WITH RAIL SYSTEM, describes a walkway system for roof, truss or elevated workers or the like attached to a structure, e.g. a building wall r1 an unfinished building. The system utilizes first and second longitudinally spaced-apart support assemblies for releasable attachment to a top of a building wall. Each assembly presents a depending support bar extending along an exterior surface of a building wall. A horizontal support brace is attached to each depending support bar at selectable positions therealong, the horizontal support brace providing support for overlying boards of a walkway. Attached to the free end of the horizontal support brace is a vertical post having a plurality of vertically spaced-apart brackets thereon for receiving a portion of a plurality of vertically spaced apart hand rails therein. A series of hook-like brackets are releasably placed along the rails for positioning a reinforcing strut adjacent each hand rail. The walkway can be vertically offset from the top of the building wall as well as laterally extended therefrom. The walkway with reinforced hand rails is effective in presenting a barrier to preclude workers from falling onto the ground.

U.S. Pat. No. 6,666,298, titled HANGING SCAFFOLD SUPPORT, describes a scaffolding support designed to hang from the top of a wall and further designed to allow a complete roof including a frieze block to be installed without removing the hanging scaffolding support. The hanging scaffolding support is further designed to be removable with a frieze block installed. The hanging scaffolding support includes a wall securing assembly, a vertical support, a horizontal support, and a vertical safety rail support.

U.S. Pat. No. 6,886,662, titled HANGING SCAFFOLD SUPPORT, describes A scaffold support system having an adjustable-width hanger. A vertical leg may support a foot upon which rests a deck, providing a working surface during building construction or modification. A lateral beam rests on a support structure forming part of the wall of a building with the vertical leg securing to the lateral beam at a plurality of points. A stop secured to the lateral beam to capture a support structure between itself and the vertical leg. The stop may be adjustable along the lateral beam to accommodate support structures of varying widths. An operator may insert the hanger from inside a building and pass the coupler through a gap between a frieze block and a top plate, presenting the coupler for securement to the vertical leg. A catch may slide along the foot into and out of engagement with an edge of the deck to prevent rotation of the deck.

### BRIEF DESCRIPTION OF THE DRAWINGS

FIG. 1 illustrates a perspective view of a construction safety system removably attached to a building, according to an example embodiment.

FIG. 2 illustrates a side view of a wall bracket according to an example embodiment.

FIG. 3 illustrates a front view of the wall bracket of FIG. 2.

FIG. 4 illustrates a back view of the wall bracket of FIG. 2.

FIG. 5 illustrates a side view of a platform support bracket according to an example embodiment.

FIG. 6 illustrates an elevational, front view of the platform support bracket of FIG. 1, according to an example embodiment.

FIG. 7 illustrates a perspective view of the key of the wall bracket and the keyhole of the platform support bracket, according to an example embodiment.

FIG. 8 illustrates a cut away side view of the keyhole in the vertical bar of the platform support bracket 400, according to an example embodiment

FIG. 9 illustrates an assembly of the wall bracket and the platform support bracket on a wall, according to an example embodiment.

FIG. 10 illustrates a system of the assemblies according to an example embodiment.

All Figures are illustrated for ease of explanation of the basic teachings of various embodiments of the present invention only; the extensions of the Figures with respect to number, position, relationship and dimensions of the parts to form the preferred embodiment(s) will be explained or will be within the skill of the art after the following description has been read and understood. Further, the exact dimensions and dimensional proportions to conform to specific force, weight, strength, and similar requirements for various applications will likewise be within the skill of the art after the following description has been read and understood.

Where used in various Figures of the drawings, the same numerals designate the same or similar parts. Furthermore, when the terms “top,” “bottom,” “right,” “left,” “front,” “rear,” “first,” “second,” “inside,” “outside,” and similar terms are used, the terms should be understood to reference only the structure shown in the drawings and utilized only to facilitate describing the illustrated embodiments. The terms should be understood to reference the structures shown in the drawings as they will typically be utilized by user, e.g., construction worker or roofer, of the apparatus and systems shown and described herein in accordance with embodiments of the present invention.

### DETAILED DESCRIPTION

The Figures generally illustrate exemplary embodiments of a construction safety device and system, for example, a roofing safety system. Examples of the present disclosure can be used in the construction trades for residence construction, retail construction, or commercial construction. Also illustrated are methods for implementing aspects of the construction safety system. These illustrated embodiments are not meant to limit the scope of coverage but, instead, to assist in understanding the context of the language used in this specification and in the appended claims. Accordingly, the appended claims may encompass variations of described systems and methods for using the system that differ from the illustrated embodiments.

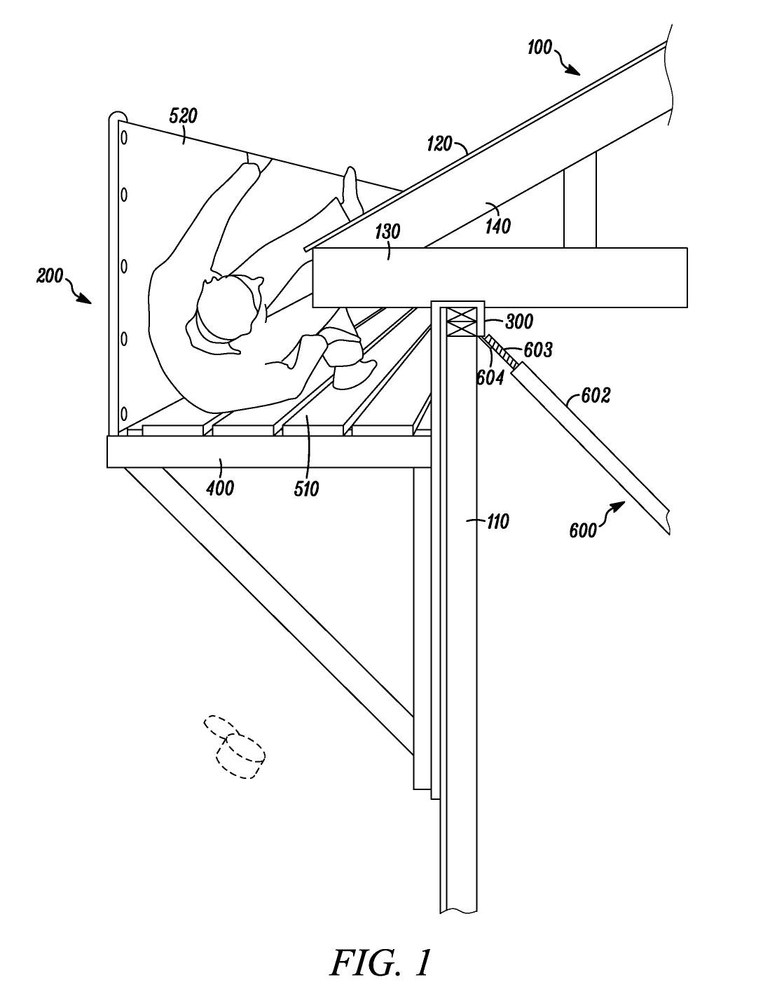

FIG. 1 illustrates a perspective view of a construction safety system 200 removably attached to a building or structure 100 under construction, according to an example embodiment. More specifically, the construction safety system 200 is attached to a wall 110 or wall portion 110 of the building 100. The construction safety system 200 includes a plurality of wall brackets 300 and a plurality of platform support brackets 400. The platform support brackets 400 support a platform 510 and support a substantially vertical obstacle or barrier 520 to prevent or stop a fall of a person working on a roof 120 of a structure, which can be the building 100 or the building under construction, remodel or repair. The construction safety system 200 is positioned so that it presents a platform 510 below a soffit or overhang 130 of the roof 120 on the structure 100. The platform 510 is positioned so that it also will give construction workers a working surface from which they can install sheathing or decking onto a series of roof trusses 140 (only one is shown in FIG. 1) as the roof 120 is being constructed. The platform 510 also provides a working surface from which to place the first course or the first several (i.e., toward lower edge of roof) courses of shingles when the roof 120 is shingled. The barrier 520 extends to a height above the soffit or overhang 120 so as to prevent workers from falling past the barrier 520. The construction safety system 200 remains installed as long as construction workers are working on the roof In an example, the construction safety system 200 does not necessarily prevent falls, but may help in preventing falls from turning into a very serious injury. In an example, the fall turns into a fall of about few feet onto the platform 510 instead of a fall from the roof onto the ground, e.g., one or more stories onto the ground with acceleration due to gravity. Now referring to the figures that follow, the construction safety system will be further detailed.

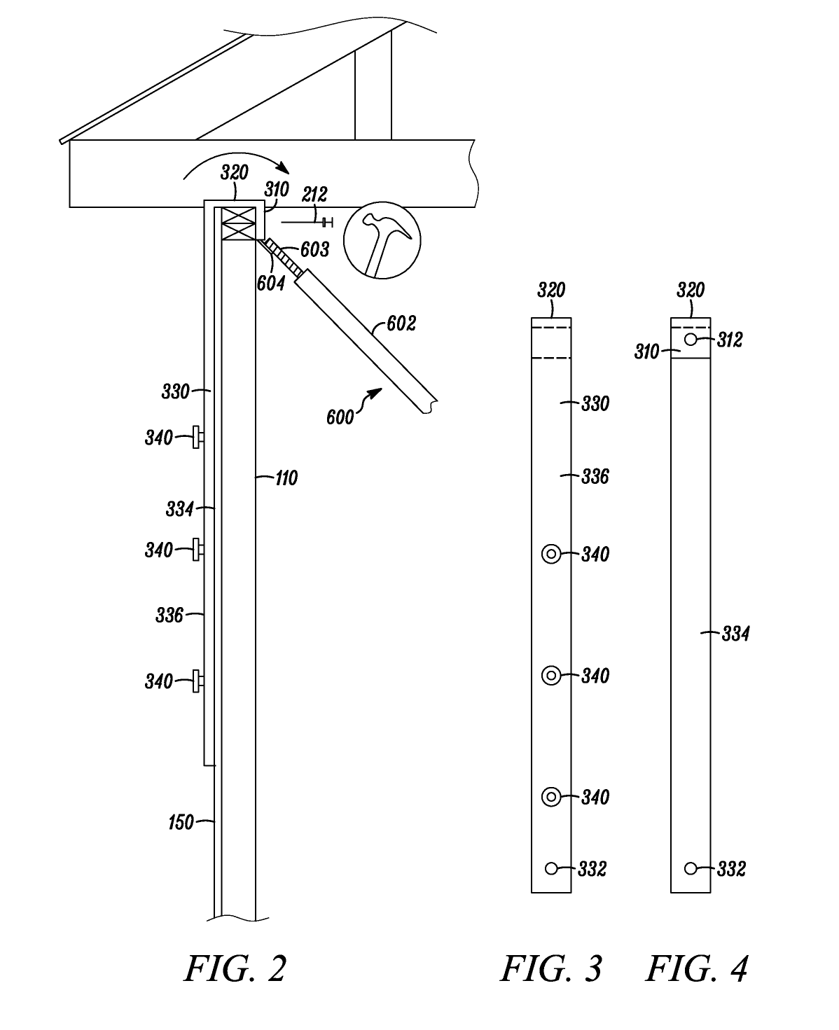

FIG. 2 illustrates a side view of a wall bracket 300 according to an example embodiment. FIG. 3 illustrates a front view of the wall bracket 300 of FIG. 2. FIG. 4 illustrates a rear view of the wall bracket of FIG. 2. The wall bracket 300 includes an interior member 310, a wall top member 320, and an exterior member 330. The interior member 310, the wall top member 320 and the exterior member 330 are integrally formed, in an example. There are no fasteners or pins for holding the interior member 310, the wall top member 320 and the exterior member 330 to one another. The wall bracket 300 is integrally formed for both ease of use and safety as well as minimizing installation time. Each such fastener introduces a potential weak spot or failure point. In addition, the more fasteners that are required, the more complex a safety system becomes and the more prone such a safety system is to either not being used at all or being used incorrectly and unsafely. Furthermore, the more fasteners that are needed also increases the set up time or installation time for such a safety system. Minimizing time or keeping the installation time to a reasonable amount of time is one goal related to the instant construction safety system 200. If a safety system takes too long to install or remove, the workers are less likely to use the system. Moreover, having numerous parts, e.g., pins, connectors, fasteners, multiple adjustment pieces, ropes or lines, may result in the workers not using the system. In one embodiment, integrally formed assembly includes welding the interior member 310, the wall top member 320 and the exterior member 330 to each other as shown and described. In another embodiment, the interior member 310, the wall top member 320 and the exterior member 330 can be formed from a single sheet of metal, such as by folding or bending a properly dimensioned metal to form the wall bracket 300. In various examples, the members 310, 320 and 330 are each plate metal or a strong polymer. Additional ways for forming the wall bracket 300 are also contemplated. In an example, the wall bracket 300 can be made from an engineered polymer that has sufficient strength for supporting workers, equipment and supplies. Strength is measured in multiple hundreds of pounds of support to loads on the wall bracket.

FIG. 2 shows the wall bracket 300 installed on a wall portion of the structure 100. It should be noted that the exterior member 330 includes a wall abutting surface 334 that is substantially flat and abuts the wall portion of the structure along the wall abutting surface 334. This distributes horizontal components of the load on the construction safety system 200 over the wall abutting surface 334 and the wall portion to which it contacts. As a result, the forces are spread across a large area and not at a single point or at a width of a board. The exterior member 330 also includes a connection surface 336 which is substantially parallel to the wall abutting surface 334. Connection surface 336 is on an opposite side of the member 330 from the wall abutting surface 334. The connection surface 336 and the surface 334 have a greater surface area than the edge surfaces of the wall bracket 300. In one embodiment, the connection surface 336 of the exterior member 330 of the wall bracket 300 includes at least one key 340. In an example, there is a plurality of keys 340. The at least one key 340 extends outwardly from the connection surface 336 with a narrow post and a head that is larger in area than the body. The body can have a length that is longer than the head. The key 340 is on a surface of the exterior wall bracket 330 which is parallel to the surface of the exterior wall 110. In some embodiments, there are a number of keys 340 positioned on the connection surface 336 of the wall bracket 300.

Now referring to FIGS. 2-4, the wall bracket 300 includes a motion limiting device 312, 332, 212. The motion limiting device prevents the wall bracket from moving laterally, e.g., from side to side, on the wall. The motion limiting device also keeps the wall bracket engaged with the wall portion on which it is attached. For example, the motion limiting device prevents the bracket 300 from moving vertically, e.g., upwardly, on the wall. The weight of the bracket 300 and system, when fully assembled, also holds the bracket in place on the wall. In an embodiment, the interior member 310 includes a fastener opening 312 therein. The fastener opening 312 includes an aperture dimensioned so as to receive a fastener, e.g., a nail, a screw, a spike, a pin, a staple, a claw, or the like. In an example, the fastener is a nail or a duplex nail. In some embodiments, the exterior member 330 also can include a fastener opening 332 therein. The fastener opening 332 includes an aperture dimensioned so as to receive a fastener, e.g., nail. In still other embodiments both the interior member 310 and the exterior member 330 include fastener openings 312, 332 respectively. The fastener opening can be used to limit the side to side motion of the wall bracket or to tie it to the wall portion 110 to which the wall bracket 300 is attached. As shown in FIG. 2, a fastener (e.g., a nail) 212 can passed into the opening 312 in the interior member and into a header of the wall (shown as a double top plate in FIG. 2) with the fastener head remaining on or outside the interior member 310. The wall portion 110 will generally include a stud within the wall. In an example, the fastener 212 can pass into the opening 312 and into the wall stud with the fastener head remaining on or outside the interior member 310. This fastener limits the motion of the wall bracket 330 and keeps it positioned over a stud in the wall portion 110. The fastener 212 shown is a duplex or form nail which can be easily removed. It should be noted that any nail can be used. Although no fastener is shown, a fastener can be driven through opening 332 in the exterior member 330 to further immobilize or limit the motion of the wall bracket 330. The fastener opening 332 is placed so that a fastener (e.g., a nail) positioned in the nail opening 332 will not interfere with platform support bracket (shown in FIG. 1) as connected to the wall bracket 330. While described as a nail, other fastening devices can be used to secure the wall bracket in place. Examples of other fasteners or fastening devices include, but are not limited to, screws, bolt, pins, tacks, brads, and spikes.

As shown in FIGS. 1 and 2, the exterior member 330 extends downwardly from the wall top member 320 flat against an exterior wall 150 of a building 110. In some embodiments the wall top member 320 also is flat against the top of the wall, e.g., over the top plate. In still other embodiments, the wall bracket 330 is dimensioned so that the exterior member 330, the wall top member 320 and the interior member 310 all are flat against corresponding wall portions, e.g., top plate, header, or exterior sheathing. The wall top member 320 can be adjustable to control the distance between the members 310, 330 to more securely affix the wall bracket 300 to the building surface.

Referring to FIGS. 1 and 2, a wall brace 600 is provided during the raising of the wall 110 to hold the wall in the vertical position. The wall brace 600 can have a leg 602 and an extension 603 that extends from a top end of the leg 602. In an example, the extension 603 is threadedly engaged with the arm 602 so that the length of the wall brace 600 can be changed be rotational movement of the extension 603 relative to the arm 302. A head 604 is fixed to the top free end of the extension 603. The head 604 is angled to engage the top of the wall 110, e.g., the top plate. In an example, the head 604 includes at least one fastener receiving aperture that can align with the opening 312 on the interior member 310 such that a fastener, such as a nail or the like, can extend through both the interior member 310 and head 604 to fix the wall bracket 300 and the wall brace 600 to the wall 110. The wall brace 600 can also include a foot (not shown in FIG. 2) that can be fixed to the floor (e.g., nailed or screwed to the floor or sub-floor) inside the structure defined by the wall 110. In an example, the wall brace 600 can be removed when the fastener 212 is removed from the head 604.

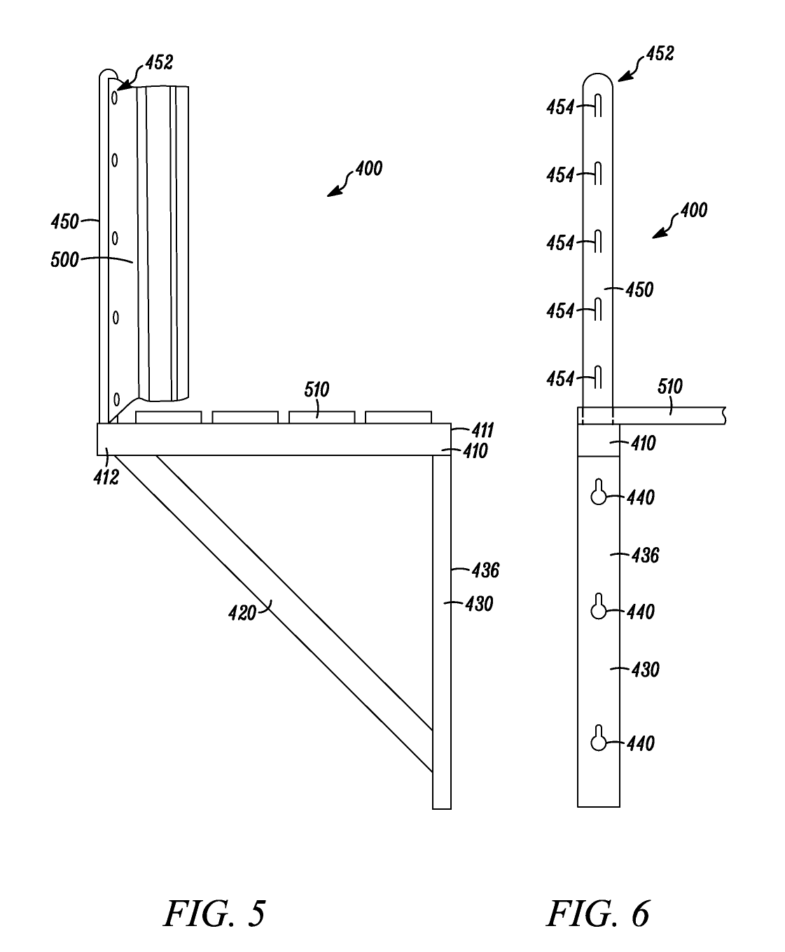

FIG. 5 illustrates a side view of a platform support bracket 400 according to an example embodiment. FIG. 6 illustrates a front view of the platform support bracket 400 of FIG. 5. The platform support bracket 400 defines a platform 510 to support a person and also defines a rear (left in FIGS. 1, 5, 9 and 10) obstacle 520. The obstacle 520 is outward of the side of the building and at an outer side of the platform 510. The platform support bracket 400 includes a substantially vertical bar 430 to be positioned adjacent the exterior member 330, a substantially horizontal bar 410 with a first end 411 fixed to a top of the vertical bar 430 and a second end 412, and a brace 420. The brace 420 extends from the substantially vertical bar 430 to the substantially horizontal bar 410 to support the substantially horizontal bar 410 outwardly from the substantially vertical bar 430. The brace 420 has a lower end fixed adjacent or at the lower end of the bar 430 and an upper end fixed to a rearward end of the bar 410. Extending upwardly from the second end 412 of the horizontal bar 410 of the platform support bracket is a stanchion 450. The fixing of the various components of the bracket 400 is a permanent fixing. In an example, this is by welding. In an example, the bars 410, 420, and 430 can be held together by bolts and nuts. While described as bars, components 410, 420, 430 can be fabricated from metal or engineered polymers with sufficient strength and reliability.

The stanchion 450 includes a fastening system 452. The fastening system 452 is adapted to attach a portion of a barrier 520. In one embodiment of the fastening system 452, the stanchion 450 includes at least one hook 454 adapted to hold a portion of a barrier 450. In some embodiments, the stanchion includes a plurality of hooks 454 or other fasteners for holding a portion of a barrier. As shown in FIG. 6, the stanchion 450 includes five hooks 454 which are spaced along the length of the stanchion 510. The hooks 454 engage openings in the obstacle or barrier 510, as shown in FIG. 5. In other embodiments, the stanchion 450 includes a plurality of other fasteners for holding a portion of a barrier or obstacle 510.

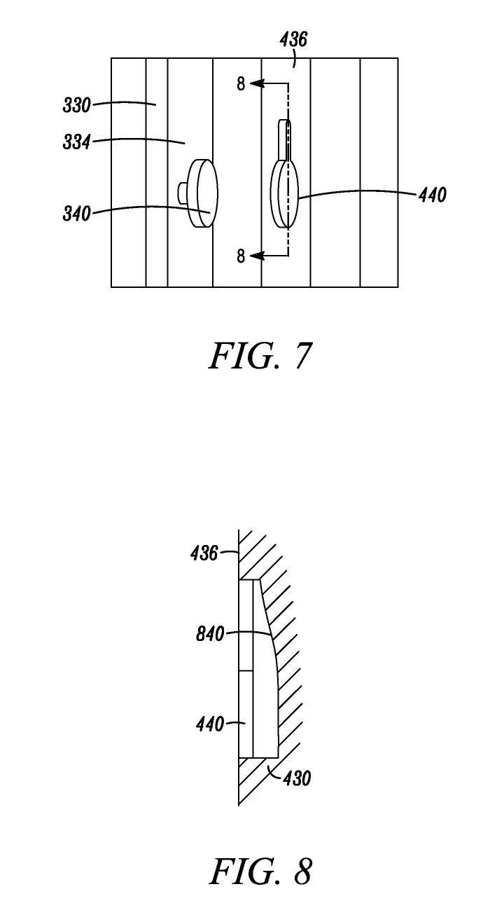

The platform wall bracket 400 includes at least one keyhole 440 designed to receive the key 340 from the wall bracket 300 and removeably fix the wall bracket 300 to the platform support bracket 400. FIG. 7 illustrates a perspective view of the key 340 of the wall bracket 300 and the keyhole 440 of the platform support bracket 400, according to an example embodiment. The bottom of the keyhole 440 allows the head of the key 340 to pass therethrough. The top of the keyhole 440 narrows to a width associated with the radius of the post associated with the key 340. The force of gravity pulls the platform support bracket 400 down with respect to the wall bracket 300. This movement causes the key 340 to move into a locking position where the enlarged head of the key is positioned behind the narrow slot at the top of the keyhole 440.

FIG. 8 illustrates a cut away side view of the keyhole 440 in the vertical bar 430 of the platform support bracket 400, according to an example embodiment. In some embodiments, the opening 440 associated with the keyhole 440 includes an inclined wedge surface 840. The wedge surface 840 produces a gap 842 that necks down or narrows as the key 340 further engages the keyhole 440. The wedge surface 840 wedges the key 340 into the wall portion 441 that covers a portion of the keyhole 440 on platform support bracket 400 as the key 340 engages the keyhole 440. The wedge surface creates an interference fit to assist in holding the bar 430 to the member 330. The wedge surface may also create a press fit between the bar 430 and the member 330. Of course, it should be pointed out that the position of the key and the keyhole could be switched as remain within the scope of the present disclosure. The key could be positioned on the vertical bar 430 of the platform support member and the keyhole could be in the exterior member 330 of the wall bracket 300. In this embodiment, the exterior member 330 would need an internal opening so that the key would not engage the surface of the wall beneath the wall bracket 300.

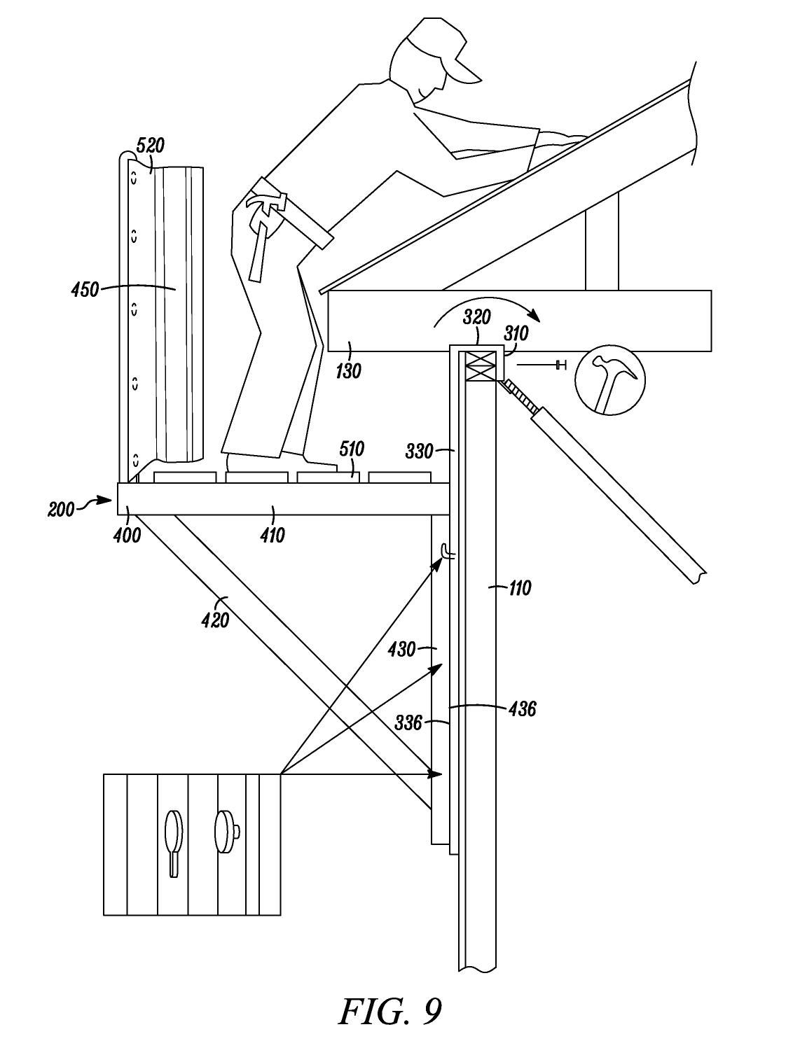

FIG. 9 illustrates an assembly of the wall bracket 300 and the platform support bracket 400 on a wall 110 of a structure, according to an example embodiment. The exterior member 330 of the wall bracket 300 is flat against the wall 110 to distribute any horizontal load over the surface of the wall, e.g., an underlying stud associated with the wall. This prevents localized stresses that could bow the wall or the stud and produce a bow on the interior surface of the wall that would have to be covered or repaired when finishing the interior of the structure. The wall top member 320 and the interior member 310 of the wall bracket 300 also fit flat against corresponding wall portions. The wall top member 320 can be adjustable so that both members 310 and 330 lie essentially flat against the wall or part of building to which they are mounted. The wall top member 320 can be two plates that move relative to each other and locked into position before mounting the wall bracket 300. In an example, the moveable components of the wall top member 320 are joined so that they cannot be fully separated from each other.

The platform support bracket 400 is attached to the exterior member 330 along the vertical bar 430 of the platform support bracket 400. The contact surface 336 abuts the contact surface 436 of the vertical bar 430. The horizontal bar 410 supports the platform 510 such that a person can safely stand on the platform. In addition, the platform may also support several squares of shingles while supporting a user so that the user can easily move shingles from a square to a selected position on the roof during roofing operations. Other building materials can also be supported on the platform 510. The stanchion 520 includes a fastening system for fastening a barrier or obstacle.

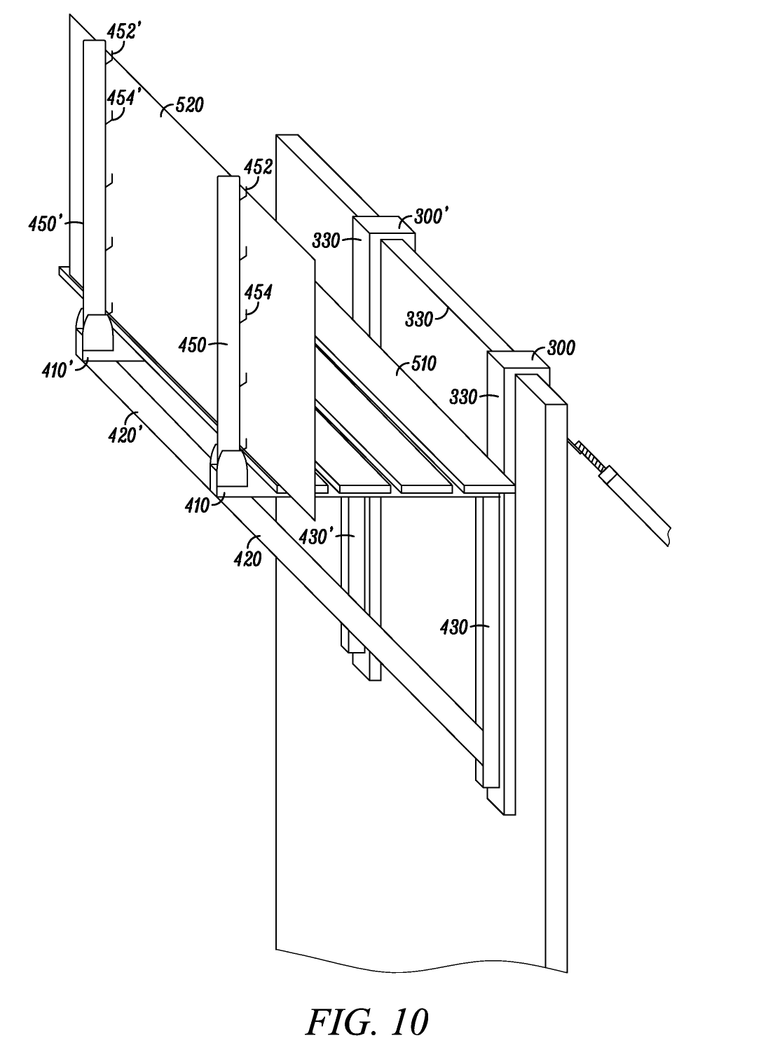

FIG. 10 illustrates a system 1000 of the assemblies according to an example embodiment. The system 1000 includes a first construction safety device 200 and a second construction safety device 200′ that are removably attached to a building or structure 100 at selected positions on the wall 110. The selected positions, in an embodiment, correspond to the position of the studs in the wall 110. The construction safety system 1000 includes a first wall bracket 300, and a first platform support bracket 400, and a second wall bracket 300′ and a second platform support bracket 400′. The first wall bracket 300 is positioned over a first wall portion 110. The second wall bracket 300′ is positioned over a second wall portion 110′. The first platform support bracket 400 is removably attached to the fist wall bracket 300. The second platform support bracket 400′ is removably attached to the second wall bracket 300′. A platform 510 is placed onto the first platform support bracket 400 and the second platform support bracket 400′. The platform 510 spans the distance between the first platform support bracket 400 and the second platform support bracket 400′. The platform 510 has a width and length to prevent users from falls past the platform 510. The platform 510 is dimensioned so that it occupies most of the space between the first platform support bracket 400 and the second platform support bracket 400′. A barrier 520 is attached to the first stanchion 450 of the first platform support bracket 400 and the second stanchion 450′of the second platform support bracket 400′. The first stanchion 450 has a first fastening system 452 and the second stanchion 450′ has a second fastening system 452′ to hold the barrier 520 securely. The barrier 520 is held securely by the stanchion fastening systems 452, 452′ so as to prevent users from falling past the barrier 450. The barrier 520 also has a width and length to prevent users from falling past the barrier 520. The barrier 520 extends to a position above the soffit or overhang 130 on a residence, in one application. In another embodiment, the barrier 520 extends above the bottom roofline of a residence. In one embodiment, the barrier 520 is a mesh. The mesh comes in a roll and is made of a plastic material. The first stanchion 450 and second stanchion 450′ each include a plurality of hooks 454 along the height of the stanchion 450, 450′. The plurality of hooks 454 engage the mesh or pass through openings in the mesh to hold the mesh in place. These openings can be reinforced to prevent tearing of the mesh. The mesh is stretched between the stanchions 450, 450′ so as to provide a secured safety net to catch users and prevent them from falling past the stanchions and specifically past the barrier. The mesh can be a polymer material that has sufficient strength to prevent a person from breaking through the mesh barrier.

The wall bracket 300 and the platform support bracket 400 generally are removably fixed with respect to one another. At least one of the first or second exterior member 330 of the wall bracket 300 includes a key 340 extending outwardly from the exterior wall. The corresponding first or second platform support bracket 400, 400′ includes a keyhole 440, 440′to receive the key 340, 340′ and removeably fix the at least one of the first or second wall bracket 300, 300′ to the at least one of the first or second platform support bracket 400, 400′. In one embodiment, the keyhole includes an inclined surface 840 that serves to wedge the key 340 into the keyhole 440 as it further engages the keyhole. In one embodiment, the wall bracket 300 and the platform support bracket 400 are fixed or secured to one another so that the wall bracket 300 and platform support bracket 400 are removed from the wall as one piece. The platform support bracket 400 is later removed from the wall bracket 300 using a hammer or sledge hammer if the brackets 300 and 400 are held together with a wedge press fit between the key and keyhole. The first wall bracket 300 and the second wall bracket 300′ include nail openings for tying the first wall bracket 300 and the second wall bracket 300′ to the exterior wall. Any nails used to tie the first and second wall brackets 300, 300′ to the wall must be removed to remove the wall bracket and platform support brackets.

In use, the scaffolding system can be used as follows. The wall framers can install the wall bracket when framing the wall. The wall bracket extends over the top of the wall and will have an exterior member along the outside of the wall. The platform bracket is then fixed to the wall bracket. The worker can then reach the roof and complete roof framing, sheathing, addition of roof paper, and roofing materials. Construction workers can also install the fascia from the platform. Depending on the interior design of the building, the wall bracket can be left in place until the drywall or interior finish is needed. In some designs, the wall brace can be removed and the platform can remain in place when interior finish work is completed. In an example, the brick layers or siding installers can remove the scaffold system, i.e., platform bracket and wall bracket, as they bring their scaffold up to finish the exterior of the building. The system, e.g., the wall bracket, will be removed prior to installation of the soffit.

The devices and systems described herein can be used by construction workers with little training and does not require the workers to provide additional components. In some prior roofing safety devices, require the installation of pivots of stringers at the roof peak. These systems attach the workers by lines, which can become entangled. Moreover, some work on the roof must be done prior to installation of such devices. The presently described device can be installed prior to any work on the roof That is, once the walls are raised the construction safety system 200 of the present application can be installed. In an example, the wall can be constructed and the wall bracket 300 installed prior to raising the wall. After the wall is raised, the platform support bracket 400 can be attached to the wall bracket 300. In other examples, the entire system 200 can be assembled prior to raising the wall. Other prior are platforms focus the load of the platform at a lower end of the platform. The platform can further require a stringer onto which the platform is affixed. Embodiments of the present invention do not require stringer. Compliance and use will increase by not using a stringer. Safety is believed to be increased as at various construction sites a stringer of sufficient length may not be available. Sufficient length may be defined as the entire length of the scaffold. Workers may then use scrap, which may not be safe. The present system does not use pins or removable bolts to construct either the wall bracket or the platform bracket. This reduces the possible failure points of the present system.

Although a few variations have been described and illustrated in detail above, it should be understood that other modifications are possible. In addition it should be understood that the logic flow depicted in the accompanying figures and described herein do not require the particular order shown, or sequential order, to achieve desirable results. Other embodiments may be within the scope of the following claims.

The foregoing discussion discloses and describes merely exemplary embodiments of the present inventions. Upon review of the specification, one skilled in the art will readily recognize from such discussion, and from the accompanying figures and claims, that various changes, modifications and variations can be made therein without departing from the spirit and scope of the invention as defined in the following claims.

What is claimed is:

1. A construction safety device, comprising:
a wall bracket, including a interior member, a wall top member and an exterior member, which are integrally formed, the exterior member extending downwardly from the wall top member flat against an exterior wall of a building;
a platform support bracket connected to the wall bracket, the platform support bracket defining a platform to support a person and a rear obstacle, the platform support bracket including:
a substantially vertical bar to be positioned adjacent the exterior member,
a substantially horizontal bar with a first end fixed to a top of the vertical bar and a second end,
a brace extending from the substantially vertical bar to the substantially horizontal bar to support the substantially horizontal bar outwardly from the substantially vertical bar,
a stanchion extending upwardly from the second end of the horizontal bar.

2. The construction safety device of claim 1, wherein the exterior member of the wall bracket includes a key extending outwardly from the exterior wall, and the platform wall bracket includes a keyhole to receive the key and removeably fix the wall bracket to the platform support bracket.

3. The construction safety device of claim 2, wherein the keyhole within the platform wall bracket includes an inclined wedge surface for wedging the key into the platform support bracket as the key enters the keyhole.

4. The construction safety device of claim 1, wherein the stanchion includes a fastening system adapted to attach a portion of a barrier to the stanchion.

5. The construction safety device of claim 4, wherein the stanchion includes at least one hook adapted to hold a portion of a barrier.

6. The construction safety device of claim 1, wherein the wall bracket includes a motion limiting device.

7. The construction safety device of claim 7, wherein the interior member of the wall bracket includes a fastener aperture therein.

8. The construction safety device of claim 7, wherein the exterior member of the wall bracket includes a nail opening therein.

9. The construction safety device of claim 7, wherein the interior member includes a nail opening therein, and the exterior member of the wall bracket includes a nail opening therein.

10. A construction safety system, comprising:
a first wall bracket, including a first interior member, a first wall top member and a first exterior member, which are integrally formed, the first exterior member extending downwardly from the first wall top member flat against an exterior wall of a building;
a first platform support bracket connected to the first wall bracket, the first platform support bracket defining a platform to support a person and a rear obstacle, the first platform support bracket including:
a first substantially vertical bar to be positioned adjacent the exterior member,
a first substantially horizontal bar with a 1st end fixed to a top of the first vertical bar and a second end,
a first brace extending from the substantially vertical bar to the first substantially horizontal bar to support the substantially horizontal bar outwardly from the first substantially vertical bar, and
a first stanchion extending upwardly from the second end of the first substantially horizontal bar;
a second wall bracket, including a second interior member, a second wall top member and a second exterior member, which are integrally formed, the second exterior member extending downwardly from the second wall top member flat against an exterior wall of a building;
a second platform support bracket connected to the second wall bracket, the second platform support bracket defining a platform to support a person and a rear obstacle, the second platform support bracket including:
a second substantially vertical bar to be positioned adjacent the exterior member,
a second substantially horizontal bar with a 1st end fixed to a top of the second vertical bar and a second end,
a second brace extending from the substantially vertical bar to the second substantially horizontal bar to support the substantially horizontal bar outwardly from the second substantially vertical bar, and
a second stanchion extending upwardly from the second end of the second substantially horizontal bar;
a platform extending between the first platform support bracket, and the second platform support bracket; and
a barrier extending between the first stanchion and the second stanchion.

11. The construction safety system of claim 10, wherein the platform has a width and length to prevent users from falls past the platform.

12. The construction safety system of claim 11, wherein the barrier has a width and length to prevent users from falling past the barrier.

13. The construction safety system of claim 12, wherein the first stanchion and the second stanchion each include a fastening system to attach the barrier to the first stanchion and the second stanchion.

14. The construction safety system of claim 12, wherein the barrier includes a mesh.

15. The construction safety system of claim 10, wherein at least one of the first exterior member or second exterior member include a key extending outwardly from the exterior wall, and wherein at least one of the first platform wall bracket or second platform support bracket includes a keyhole to receive the key and removeably fix the at least one of the first or second wall bracket to the at least one of the first or second platform support bracket.

16. The construction safety system of claim 15, wherein at least one of the keyholes includes an inclined wedge surface to wedge the key into the platform support bracket as the key enters the keyhole.

17. The construction safety system of claim 10, wherein the first wall bracket and the second wall bracket each include a fastener aperture to tie the first wall bracket and the second wall bracket to the exterior wall.

18. The construction safety system of claim 17, wherein at least one of the first wall bracket and the second wall bracket include a wall brace connected to the interior member to assist in holding a wall in a vertical position.

19. The construction safety system of claim 17, wherein the wall brace include a head positioned between the interior member and a top plate of the wall.
